(19) United States
(12) Patent Application Publication
(10) Pub. No.: US 2015/0244521 A1
(43) Pub. Date: Aug. 27, 2015

(54) COMMUNICATION ENCRYPTION AND DECRYPTION METHOD, DEVICE AND SYSTEM

(71) Applicant: TENCENT TECHNOLOGY (SHENZHEN) COMPANY LIMITED, Guangdong (CN)

(72) Inventors: Shusheng Chen, Shenzhen City (CN); Kun Zhang, Shenzhen City (CN); Zhengxiang Xiong, Shenzhen City (CN); Yingxue Liu, Shenzhen City (CN); Yue Zang, Shenzhen City (CN)

(21) Appl. No.: 14/430,837

(22) PCT Filed: Sep. 11, 2013
(86) PCT No.: PCT/CN2013/083291

§ 371 Date: Mar. 24, 2015

(30) Foreign Application Priority Data
Sep. 24, 2012 (CN) 201210358087.0

(51) Int. Cl. H04L 9/08

(52) U.S. Cl. CPC H04L 9/0891; H04L 9/088; H04L 2209/34

(57) ABSTRACT

An encryption process comprises: extracting a to-be-encrypted first character string from the to-be-transmitted information; converting the first character string into a plurality of first binary numbers for storage; encrypting the stored plurality of first binary numbers according to a preset encryption algorithm to generate a plurality of second binary numbers; converting the plurality of second binary numbers into a to-be-transmitted character string; conducting transmission encoding on the to-be-transmitted character string, and transmitting the encoding result. The decryption process comprises: receiving the to-be-processed information transmitted by a transmitting terminal; conducting transmission decoding on the to-be-processed information to obtain a third character string; converting the third character string into a plurality of third binary numbers for storage; decrypting the stored plurality of third binary numbers according to a preset decryption algorithm to generate a plurality of fourth binary numbers; and converting the plurality of fourth binary numbers into a fourth character string.

### TECHNICAL FIELD

The present disclosure relates to information processing techniques, and particularly, to a method, apparatus and system for communication encryption and decryption.

### BACKGROUND

Data exchanged between clients used by users and server side devices should be encrypted during a whole communication process to ensure safety of user information and avoid leakage of user information. At present, popular encryption algorithms include TEA, BASE64, MD5 and so on.

### SUMMARY

A method for communication encryption may include:

extracting a first character string that is to be encrypted from to-be-sent data;

converting the first character string into plural first binary digits, storing the plural first binary digits;

encrypting the stored plural first binary digits using a pre-defined encryption algorithm to generate plural second binary digits;

converting the plural second binary digits into a to-be-sent character string; and

applying transmission encoding to the to-be-sent character string and sending a result of the encoding.

A method for communication decryption may include:

receiving to-be-processed data sent by a sending device;

applying transmission decoding to the to-be-processed data to obtain a first character string;

converting the first character string into plural first binary digits, storing the plural first binary digits;

decrypting the stored plural first binary digits using a pre-defined decryption algorithm to generate plural second binary digits;

converting the plural second binary digits into a second character string.

An apparatus for communication encryption may include:

an extraction module, configured for extracting a first character string that is to be encrypted from to-be-sent data;

a conversion module, configured for converting the first character string obtained by the extraction module into plural first binary digits and storing the plural first binary digits;

an encryption module, configured for encrypting the stored plural first binary digits using a pre-defined encryption algorithm to generate plural second binary digits;

wherein the conversion module is further configured for converting the plural second binary digits into a to-be-sent character string;

an encoding module, configured for applying transmission encoding to the to-be-sent character string generated by the conversion module; and a sending module, configured for sending an encoding result generated by the encoding module.

An apparatus for communication decryption may include:

a reception module, configured for receiving to-be-processed data sent by a sending device;

a decoding module, configured for applying transmission decoding to the to-be-processed data received by the reception module to obtain a first character string;

a conversion module, configured for converting the first character string into plural first binary digits, and storing the plural first binary digits;

a decryption module, configured for decrypting the stored plural first binary digits using a pre-defined decryption algorithm to generate plural second binary digits;

wherein the conversion module is further configured for converting the plural second binary digits into a second character string.

A system for communication encryption and decryption, including the above apparatus for communication encryption and the above apparatus for communication decryption.

The method, apparatus and system for communication encryption and decryption according to examples of the present disclosure implements encryption and decryption by converting to-be-sent data into binary digits and stores the binary digits, encrypting or decrypting the stored binary digits and converting an encryption result or a decryption result into a character string for further usage.

### BRIEF DESCRIPTION OF THE DRAWINGS

FIG. 1 is a schematic diagram illustrating a communication system in accordance with an example of the present disclosure;

FIG. 2 is a schematic diagram illustrating modules of a computing device in accordance with an example of the present disclosure;

FIG. 3 is a flowchart illustrating a method for communication encryption in accordance with an example of the present disclosure;

FIG. 4 is a flowchart illustrating a method for communication encryption in accordance with an example of the present disclosure;

FIG. 5 is a schematic diagram illustrating modules of a system for communication encryption in accordance with an example of the present disclosure;

FIG. 6 is a flowchart illustrating a method for communication decryption in accordance with an example of the present disclosure;

FIG. 7 is a flowchart illustrating a method for communication decryption in accordance with an example of the present disclosure;

FIG. 8 is a flowchart illustrating a method for communication decryption in accordance with an example of the present disclosure;

FIG. 9 is a schematic diagram illustrating modules of an apparatus for communication encryption in accordance with an example of the present disclosure;

FIG. 10 is a schematic diagram illustrating modules of an apparatus for communication encryption in accordance with an example of the present disclosure;

FIG. 11 is a schematic diagram illustrating modules of an apparatus for communication encryption in accordance with an example of the present disclosure;

FIG. 12 is a schematic diagram illustrating modules of an apparatus for communication decryption in accordance with an example of the present disclosure;

FIG. 13 is a schematic diagram illustrating modules of an apparatus for communication decryption in accordance with an example of the present disclosure;

FIG. 14 is a schematic diagram illustrating modules of an apparatus for communication decryption in accordance with an example of the present disclosure;

FIG. 15 is a schematic diagram illustrating a system for communication encryption and decryption in accordance with an example of the present disclosure.

### DETAILED DESCRIPTIONS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

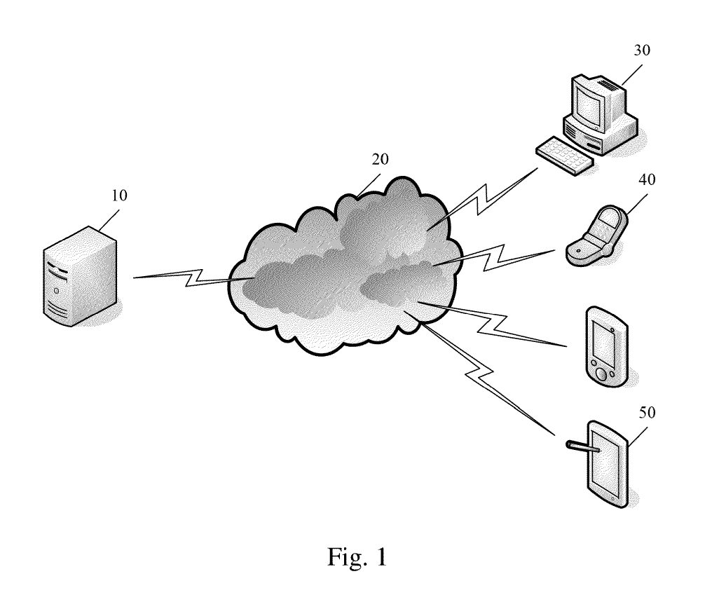

FIG. 1 is a schematic diagram illustrating a communication system in accordance with an example of the present disclosure. As shown in FIG. 1, the communication system includes a server 10, a communication network 20 and user terminal devices. The user terminal devices may be a personal computer 30, a mobile phone 40, a tablet computer 50, or other mobile Internet devices (MID), e.g., e-book reading devices, portable game consoles and the like that are capable of accessing the Internet via various wireless communications techniques. The method for communication encryption and decryption is applicable to both the above server and the user terminals. In the following, an apparatus that implements the method for communication encryption and decryption is referred to as a computing device or a computer. When the computing device implementing the encryption method is a server, the computing device implementing the decryption method which decrypts the encrypted data from the server may be a user device, and vice versa.

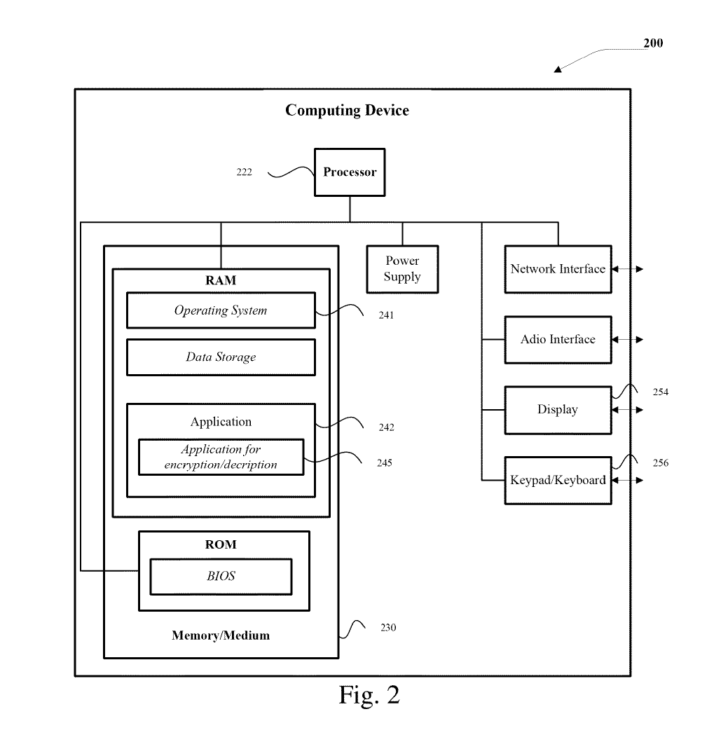

In an example, a computing device may execute methods and software systems of the present disclosure. FIG. 2 is a schematic diagram illustrating an example of a computing device. As shown in FIG. 2, the computing device 200 may be a computer capable of executing a method and software system of the present disclosure. The computing device 200 may, for example, be a device such as a personal desktop computer or a portable device, such as a laptop computer, a tablet computer, a cellular telephone, or a smart phone. The computing device 200 may also be a server that connects to the above devices locally or via a network.

The computing device 200 may vary in terms of capabilities or features. Claimed subject matter is intended to cover a wide range of potential variations. For example, the computing device 200 may include a keypad/keyboard 256. It may also comprise a display 254, such as a liquid crystal display (LCD), or a display with a high degree of functionality, such as a touch-sensitive 2D or 3D display. In contrast, however, as another example, a web-enabled computing device 200 may include one or multiple physical or virtual keyboards, and mass storage medium 230.

The computing device 200 may also include or may execute a variety of operating systems 241, including an operating system, such as a Windows™ or Linux™, or a mobile operating system, such as iOS™, Android™, or Windows Mobile™. The computing device 200 may include or may execute a variety of possible applications 242, including an application, such as a communication encryption/decryption application 245. An application 242 may perform encrypted communication with other device via a network.

Further, the computing device 200 may include one or multiple non-transitory processor-readable storage media 230 and one or multiple processors 222 in communication with the non-transitory processor-readable storage media 230. For example, the non-transitory processor-readable storage media 230 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 230 may store a series of instructions, or units and/or modules that comprise the series of instructions, for conducting operations described in the present disclosure. The one or more processors may be configured to execute the series of instructions and perform the operations in examples of the present application.

Various examples of the present disclosure provide a method for communication encryption which is applicable to computing devices capable of performing WEB-based communications, e.g., client devices such as a mobile phone, a tablet computer and server devices such as servers of an operator or a service provider.

In an example, at least one encryption module and at least one decryption module or a communication encryption/decryption application is required respectively in computing devices of two communicating parties, e.g., a client device and a server device. The communication encryption/decryption application may be implemented using JavaScript.

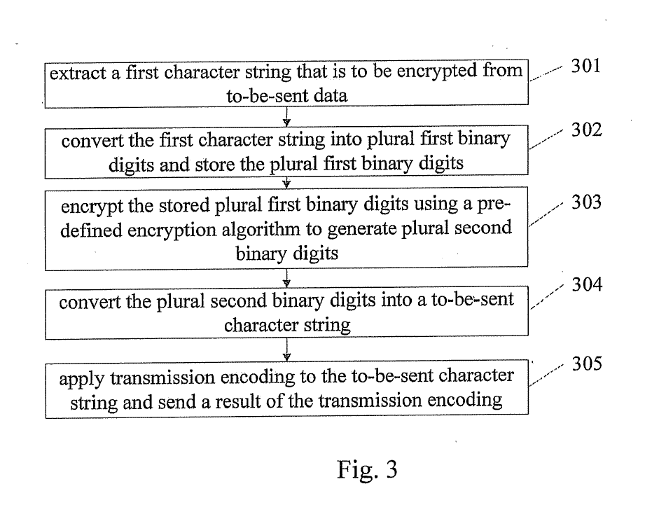

FIG. 3 is a flowchart illustrating a method for communication encryption in accordance with an example of the present disclosure. The method is a method implemented by a device having an encryption module. The method may include the following procedures.

At block 301, a first character string that is to be encrypted is extracted from to-be-sent data.

The to-be-sent data is data to be sent from a client device to a server device. The to-be-sent data may include user information for login a service such as a user name and a password and the like, or may include data of a WEB service. The data may be encrypted data or un-encrypted data, and this is not limited in the present disclosure.

In a WEB service, the to-be-sent data may be stored in the form of JSON (JavaScript Object Notation), e.g., [object Object]:{“nick”: “zixuangu”} (the “zixuangu” are three Chinese characters). A first string { “nick”: “zixuangu”} can be directly extracted from the to-be-sent data.

At block 302, the first character string is converted into plural first binary digits, and the plural first binary digits are stored.

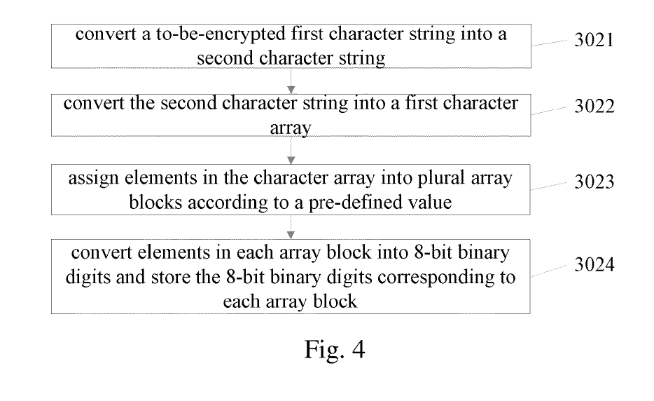

FIG. 4 illustrates an example of the process of converting the first character string into plural first binary digits and storing the plural first binary digits. The method may include the following procedures.

At block 3021, the to-be-encrypted first character string is converted into a second character string.

In an example, each character in the second character string corresponds to a byte.

In a WEB service, data is stored in the form of a character string. The data may include English characters, English symbols, Chinese characters, Chinese symbols and the like. Chinese characters are generally multi-byte characters. For example, encoded value of a Chinese character may occupy a storage space of over one byte.

The procedure of block 3021 converts characters whose encoded value occupies storage space of more than one byte into plural characters whose encoded value occupies only one byte to facilitate subsequent encryption process.

For example, in JavaScript, the first character string may be stored as Unicode codes, and may be converted into a second character string using the UTF-8 encoding scheme. For example, the first character string is “nick”: “zixuangu”, and the second character string corresponding to the first character string is “nick”:“è‡^{a}é [symbol] %oè, [symbol] ”. The above encoding scheme is only an example. Other examples may adopt other applicable encoding schemes, and the encoding scheme adopted is not limited here.

At block 3022, the second character string is converted into a first character array.

An element of the first character array corresponds to a single-byte encoded value of a character in the second character string.

In an example, since the procedure of block 302 is executed before the procedure of block 303, the encoded value corresponding to each character may be determined directly at block 303.

In an example, the ASCII codes table may be used for converting the second character string into the first character array. For example, the second character string is “nick”:“è‡^{a}é [symbol] %oè, [symbol] ”, and the first character array corresponding to the second character string is [123, 34, 110, 105, 99, 107, 34, 58, 34, 232, 135, 170, 233, 128, 137, 232, 130, 161, 34, 125].

At block 3023, elements in the first character array are assigned into plural array blocks according to a pre-defined value.

Each array block includes a pre-defined number of elements.

The pre-defined number is a natural number, and may be set according to the needs. Elements in the character array may be assigned into blocks according to the pre-defined number, and each array block includes a per-defined number of elements.

Taking the pre-defined number being 4 as an example, the procedure of assigning elements in the character array into plural array blocks may include: assigning 4 successive elements into an array block in the order of the elements arranged in the first character array.

At block 3024, elements in each array block is converted into 8-bit binary digits, and the 8-bit binary digits corresponding to each array block are stored.

Taking the pre-defined number being 4 as an example, the process of converting the elements in each array block into 8-bit binary digits and storing the 8-bit binary digits corresponding to each array block may include:

converting each of the 4 elements in each array block into an 8-bit binary digit, and the 4 8-bit binary digits corresponding to each array block are combined into a 32-bit binary digit. The 32-bit binary digits corresponding to each array block is stored.

At block 303, the stored plural first binary digits are encrypted using a pre-defined encryption algorithm to generate plural second binary digits.

The pre-defined encryption algorithm may include encryption algorithms commonly-used in current WEB services, e.g., TEA, MD5 or the like. In various example, different types of services may adopt different encryption algorithms for encrypting to-be-sent data.

At block 304, the plural second binary digits are converted into a to-be-sent character string.

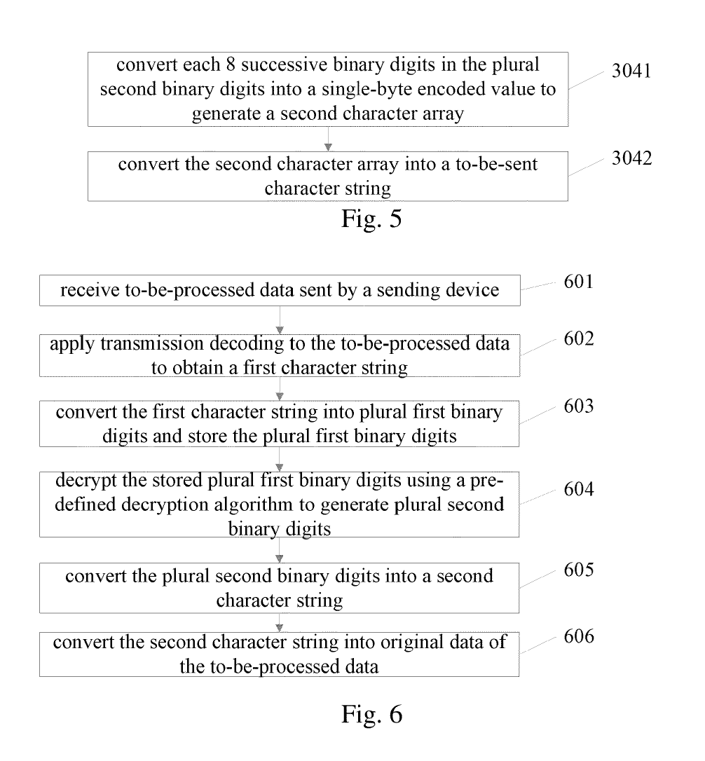

FIG. 5 illustrates a process of converting the plural second binary digits into the to-be-sent character string. The method may include the following procedures.

At block 3041, each 8 successive binary digits in the plural second binary digits are converted into a single-byte encoded value to generate a second character array.

In an example, if the first character array in block 3021 is [123, 34, 110, 105, 99, 107, 34, 58, 34, 232, 135, 170, 233, 128, 137, 232, 130, 161, 34, 125], the second character array obtained in block 3041 is [234, 109, 33, 119, 105, 146, 35, 0, 147, 240, 52, 189, 187, 172, 109, 20, 182, 48, 131, 71, 255, 98, 83, 140, 113, 228, 59, 246, 232, 150, 55, 180].

At block 3042, the second character array is converted into a to-be-sent character string.

An element of the second character array corresponds to a single-byte encoded value of a character in the to-be-sent character string.

An element of the second character array corresponds to a single-byte encoded value of a character in the to-be-sent character string.

The ASCII codes table may be used for converting the second character array into the to-be-sent character string.

For example, if the second character array is [234, 109, 33, 119, 105, 146, 35, 0, 147, 240, 52, 189, 187, 172, 109, 20, 182, 48, 131, 71, 255, 98, 83, 140, 113, 228, 59, 246, 232, 150, 55, 180], the to-be-sent character string is “êm!wi′ #”.

At block 305, the to-be-sent character string is processed through transmission encoding, and an encoded result is sent.

In order to facilitate HTTP or HTTPs transmission mechanisms, the to-be-sent character string is processed with transmission encoding in block 305.

In an example, the transmission encoding of the to-be-sent character string may adopt the BASE64 encoding scheme. For example, if the to-be-sent character string is “ê m!wi′ #”, the encoding result is 6m0hd2mSIwCT8DS9u6xtFLYwg0f/YlOMceQ79uiWN7Q=.

FIG. 6 is a flowchart illustrating a method for communication decryption in accordance with an example of the present disclosure. The method is a method implemented by a device having a decryption module. The method may include the following procedures.

At block 601, to-be-processed data sent by a sending device is received.

The to-be-processed data is the encrypted data sent by the encryption module.

At block 602, the to-be-processed data is processed through transmission decoding to obtain a first character string.

The transmission decoding of the to-be-processed data for obtaining the first character string should conform to the transmission encoding scheme used by the encryption module. The encryption/decryption algorithm and encoding/decoding scheme used by the encryption module and the decryption module may be pre-defined in the two modules, or communicated to each other in real time, and this is not limited in the present disclosure.

Taking the BASE63 encoding scheme as an example, if the to-be-processed data is 6m0hd2mSIwCT8DS9u6xtFLYwg0f/YlOMceQ79uiWN7Q=, the first character string is “êm!wi′ #”.

At block 603, the first character string is converted into plural first binary digits, and the plural first binary digits are stored.

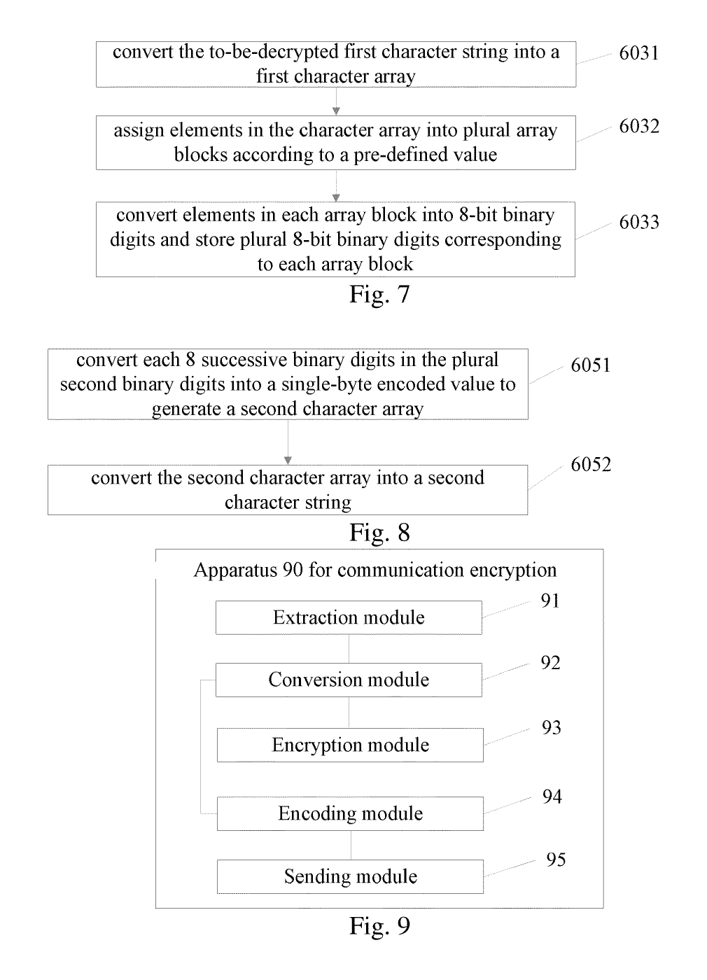

FIG. 7 illustrates a method of converting the first character string into plural first binary digits and storing the plural first binary digits. The method may include the following procedures.

At block 6031, the to-be-decrypted first character string is converted into a first character array.

An element of the first character array corresponds to a single-byte encoded value of a character in a third character string.

In an example, the ASCII codes table may be used for converting the first character string into the first character array. For example, the second character array is “ê m!wi′ #”, and the second character array corresponding to the first character string is [234, 109, 33, 119, 105, 146, 35, 0, 147, 240, 52, 189, 187, 172, 109, 20, 182, 48, 131, 71, 255, 98, 83, 140, 113, 228, 59, 246, 232, 150, 55, 180].

At block 6032, elements in the first character array are assigned into plural array blocks according to a pre-defined value.

In an example, each array block includes a pre-defined number of elements.

The pre-defined number is the same with the pre-defined number configured in the encryption module.

Taking the pre-defined number being 4 as an example, the procedure of dividing elements in the character array into plural array blocks may include: assigning 4 successive elements into one array block in the order of the elements arranged in the first character array.

At block 6033, elements in each array block is converted into 8-bit binary digits, and the 8-bit binary digits corresponding to each array block are stored.

Taking the pre-defined number being 4 as an example, the process of converting the elements in each array block into 8-bit binary digits and storing the 8-bit binary digits corresponding to each array block may include:

converting each of the 4 elements in each array block into an 8-bit binary digit, and the 4 8-bit binary digits corresponding to each array block are combined into a 32-bit binary digit. The 32-bit binary digits corresponding to each array block is stored.

At block 604, the stored plural first binary digits are decrypted using a pre-defined decryption algorithm to generate plural second binary digits.

The pre-defined decryption algorithm corresponds to the encryption algorithm configured in the encryption module.

At block 605, the plural second binary digits are converted into a second character string.

FIG. 8 illustrates a method of converting the plural second binary digits into a second character string. The method may include the following procedures.

At block 6051, each 8 successive binary digits in the plural second binary digits are converted into a single-byte encoded value to generate a second character array.

In an example, if the first character array in block 6031 is [234, 109, 33, 119, 105, 146, 35, 0, 147, 240, 52, 189, 187, 172, 109, 20, 182, 48, 131, 71, 255, 98, 83, 140, 113, 228, 59, 246, 232, 150, 55, 180], the second character array obtained in block 6051 is [123, 34, 110, 105,99,107, 34, 58, 34, 232, 135, 170, 233, 128, 137,232,130,161,34,125].

At block 6052, the second character array is converted into a second character string.

An element of the second character array corresponds to a single-byte encoded value of a character in the second character string.

In an example, the ASCII code table may be used in converting the second character array into the second character string. For example, if the second character array is [123, 34, 110, 105, 99, 107, 34, 58, 34, 232, 135, 170, 233, 128, 137, 232, 130, 161, 34, 125], the second character string is “nick”:“è‡^{a}é [symbol] %oè, [symbol] ”.

At block 606, the second character string is converted into the original data of the to-be-processed data.

In an example, the second character string in which each character corresponds to one byte is converted into a Unicode code, and the Unicode code is stored. The conversion method in block 606 may use the UTF-8 encoding scheme. For example, if the second character string is “nick”:“è‡^{a}é [symbol] %oè, [symbol] ”, the original data corresponding to the to-be-processed data is “nick”:“zixuangu”, and the “nick”:“zixuangu” may be stored in the form of JSON.

The character encoding scheme adopted in the above encryption/decryption method may be any applicable encoding scheme. The above encoding schemes are merely examples, and may be replaced with other encoding schemes.

The method for communication encryption and decryption according to examples of the present disclosure implements encryption and decryption by converting to-be-sent data into binary digits and stores the binary digits, encrypting or decrypting the stored binary digits and converting an encryption result or a decryption result into a character string for further usage. The examples convert the to-be-sent data into binary digits and store the binary digits, thus provide data of binary format for the encryption algorithm so that various encryption algorithms can be used in JavaScript environment. According to the needs of the WEB service, different encryption algorithms may be adopted, which ensures safety of user data in JavaScript environment.

FIG. 9 is a schematic diagram illustrating modules of an apparatus 90 for communication encryption in accordance with an example of the present disclosure. The apparatus may include: an extraction module 91, a conversion module 92, an encryption module 93, an encoding module 94 and a sending module 95.

The extraction module 91 is configured for extracting a first character string that is to be encrypted from to-be-sent data.

The conversion module 92 is configured for converting the first character string obtained by the extraction module 91 into plural first binary digits and storing the plural first binary digits.

The encryption module 93 is configured for encrypting the stored plural first binary digits using a pre-defined encryption algorithm to generate plural second binary digits.

The conversion module 92 is also configured for converting the plural second binary digits into a to-be-sent character string.

The encoding module 94 is configured for applying transmission encoding to the to-be-sent character string generated by the conversion module 92.

The sending module 95 is configured for sending an encoding result generated by the encoding module 94.

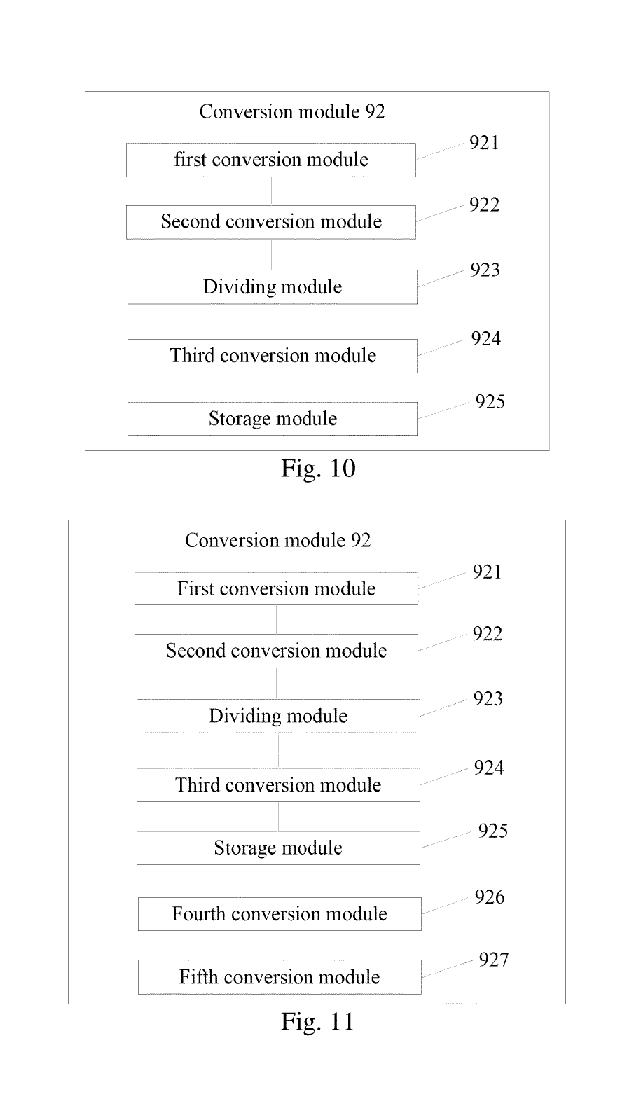

In an example as shown in FIG. 10, the conversion module 92 may include: a first conversion module 921, a second conversion module 922, a dividing module 932, a third conversion module 924 and a storage module 925.

The first conversion module 921 is configured for converting the to-be-encrypted first character string into a second character string. Each character in the second character string corresponds to one byte.

The second conversion module 922 is configured for converting the second character string obtained by the first conversion module 921 into a first character array. An element in the first character array corresponds to a single-byte encoded value of a character in the second character string.

The dividing module 923 is configured for assigning elements in the character array obtained by the second conversion module 922 into plural array blocks. Each array block includes a pre-defined number of elements.

The third conversion module 924 is configured for converting elements in each array block obtained by the dividing module 923 into 8-bit binary digits.

The storage module 925 is configured for storing multiple 8-bit binary digits corresponding to each array block obtained by the third conversion module 923.

Taking the pre-defined number being 4 as an example, the dividing module 92 may assign 4 successive elements into an array block in the order of the elements arranged in the first character array.

The third conversion module 924 is configured for converting each of the 4 elements in each array block into an 8-bit binary digit, and the 4 8-bit binary digits corresponding to each array block are combined into a 32-bit binary digit.

The storage module 925 is configured for storing the 32-bit binary digits corresponding to each array block.

In an example as shown in FIG. 11, the conversion module 92 may include: a fourth conversion module 926 and a fifth conversion module 927.

The fourth conversion module 926 is configured for converting each 8 successive binary digits in the plural second binary digits into a single-byte encoded value to generate a second character array.

The fifth conversion module 927 is configured for converting the second character array obtained by the fourth conversion module 926 into a to-be-sent character string. An element in the second character array corresponds to a single-byte encoded value of a character in the to-be-sent character string.

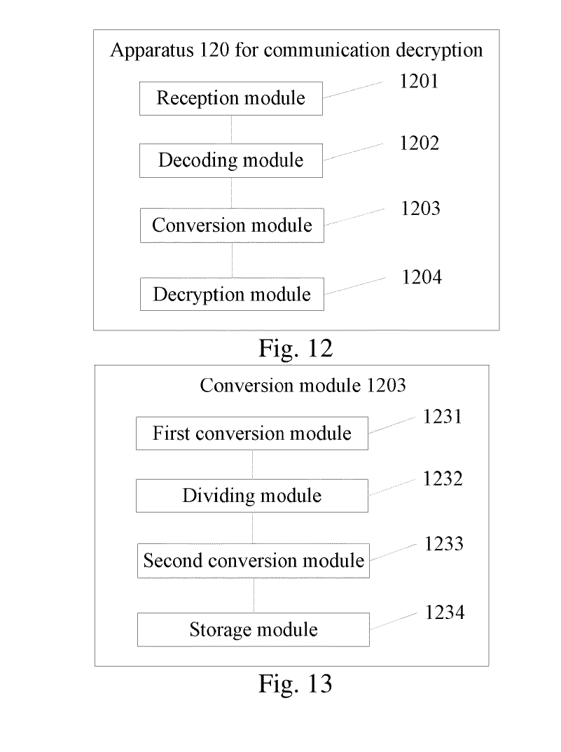

FIG. 12 is a schematic diagram illustrating modules of an apparatus 120 for communication decryption in accordance with an example of the present disclosure. The apparatus 120 may include:

a reception module 1201, configured for receiving to-be-processed data sent by a sending device;

a decoding module 1202, configured for applying transmission decoding to the to-be-processed data received by the reception module 1201 to obtain a first character string;

a conversion module 1203, configured for converting the first character string into plural first binary digits, and storing the plural first binary digits;

a decryption module 1204, configured for decrypting the stored plural first binary digits using a pre-defined decryption algorithm to generate plural second binary digits;

the conversion module 1203 is also configured for converting the plural second binary digits into a second character string.

In an example as shown in FIG. 13, the conversion module 1203 may include:

a first conversion module 1231, configured for converting the to-be-decrypted first character string into a first character array. An element in the first character array corresponds to a single-byte encoded value of a character in a third character string;

a dividing module 1232, configured for assigning elements in the character array obtained by the first conversion module 1231 into plural array blocks. Each array block includes a pre-defined number of elements;

a second conversion module 1233, configured for converting elements in each array block into 8-bit binary digits;

a storage module 1234, configured for storing the 8-bit binary digits corresponding to each array block.

In an example, the dividing module 1232 may assign 4 successive elements into an array block in the order of the elements arranged in the first character array.

The second conversion module 1233 is configured for converting each of the 4 elements in each array block into 8-bit binary digits, and the 4 8-bit binary digits corresponding to each array block are combined into a 32-bit binary digit.

The storage module 1234 is configured for storing the 32-bit binary digit corresponding to each array block.

In an example as shown in FIG. 16, the conversion module 1203 may include: a third conversion module 1235 and a fourth conversion module 1236.

The third conversion module 1235 is configured for converting each 8 successive binary digits in the plural second binary digits into a single-byte encoded value to generate a second character array.

The fourth conversion module 1236 is configured for converting the second character array obtained by the third conversion module 1235 into a second character string. An element in the second character array corresponds to a single-byte encoded value of a character in the second character string.

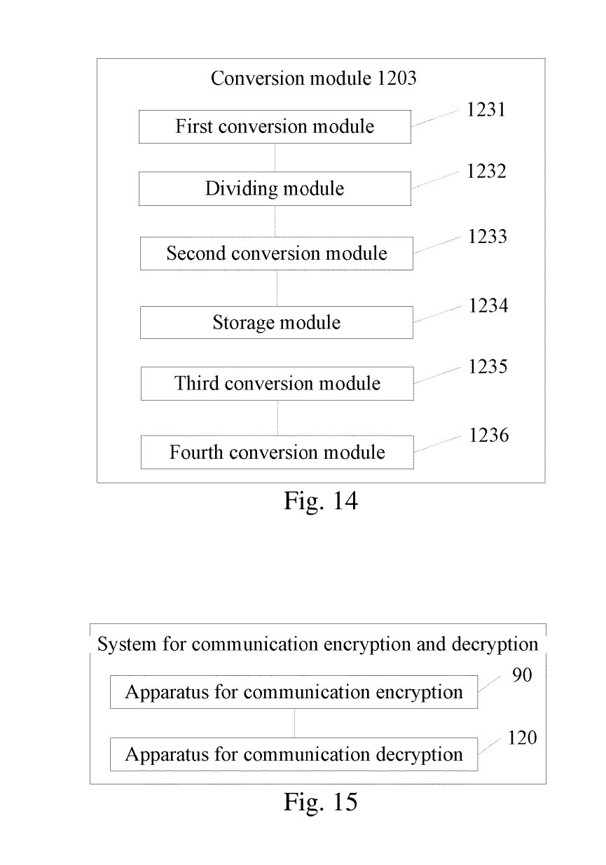

FIG. 14 is a schematic diagram illustrating a system for communication encryption and decryption in accordance with an example of the present disclosure. The system may include the above communication encryption apparatus 90 and the communication decryption apparatus 120.

The apparatus and system for communication encryption and decryption according to examples of the present disclosure implements encryption and decryption by converting to-be-sent data into binary digits and stores the binary digits, encrypting or decrypting the stored binary digits and converting an encryption result or a decryption result into a character string for further usage. The examples convert the to-be-sent data into binary digits and store the binary digits, thus provide data of binary format for the encryption algorithm so that various encryption algorithms can be used in JavaScript environment to ensure safety of user information in JavaScript environment.

It should be understood that in the above processes and structures, not all of the procedures and modules are necessary. Certain procedures or modules may be omitted according to the needs. The order of the procedures is not fixed, and can be adjusted according to the needs. The modules are defined based on function simply for facilitating description. In implementation, a module may be implemented by multiple modules, and functions of multiple modules may be implemented by the same module. The modules may reside in the same device or distribute in different devices. The “first”, “second” in the above descriptions are merely for distinguishing two similar objects, and have no substantial meanings.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions to cause a machine to execute a method as described herein. Specifically, a system or apparatus having a storage medium which stores machine-readable program codes for implementing functions of any of the above examples and which may make the system or the apparatus (or CPU or MPU) read and execute the program codes stored in the storage medium. In addition, instructions of the program codes may cause an operating system running in a computer to implement part or all of the operations. In addition, the program codes implemented from a storage medium are written in a storage device in an extension board inserted in the computer or in a storage in an extension unit connected to the computer. In this example, a CPU in the extension board or the extension unit executes at least part of the operations according to the instructions based on the program codes to realize the technical scheme of any of the above examples.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

1. A method for communication encryption, comprising:
extracting a first character string that is to be encrypted from to-be-sent data;
converting the first character string into plural first binary digits, storing the plural first binary digits;
encrypting the stored plural first binary digits using a pre-defined encryption algorithm to generate plural second binary digits;
converting the plural second binary digits into a to-be-sent character string; and
applying transmission encoding to the to-be-sent character string and sending an encoded result; wherein converting the to-be-encrypted first character string into the plural first binary digits and storing the plural first binary digits comprises:
converting the to-be-encrypted first character string into a second character string;
wherein each character in the second character string corresponds to one byte;
converting the second character string into a first character array; wherein an element in the first character array corresponds to a single-byte encoded value of a character in the second character string;
assigning elements in the first character array into plural array blocks according to a pre-defined value; wherein each array block includes elements whose number equals the pre-defined value; and
converting elements in each array block into 8-bit binary digits, and storing the 8-bit binary digits corresponding to each array block.

2. (canceled)

3. The method of claim 1, wherein when the pre-defined value is 4, the assigning single-byte encoded values corresponding to the elements in the first character array into the plural array blocks comprises:
assigning 4 successive elements into one array block in an order of the elements arranged in the first character array;
wherein the converting elements in each array block into 8-bit binary digits and storing the 8-bit binary digits corresponding to each array block comprise;
converting each of the 4 elements in each array block into an 8-bit binary digit, and combining the 4 8-bit binary digits corresponding to each array block into a 32-bit binary digit; and
storing the 32-bit binary digit corresponding to each array block.

4. The method of claim 1, wherein the converting the to-be-encrypted character string into the plural first binary digits and storing the plural first binary digits comprises:
converting each 8 successive binary digits in the plural second binary digits into a single-byte encoded value to generate a second character array; and
converting the second character array into the to-be-sent character string, wherein an element in the second character array corresponds to a single-byte encoded value of a character in the to-be-sent character string.

5. A method for communication decryption, comprising:
receiving to-be-processed data sent by a sending device;
applying transmission decoding to the to-be-processed data to obtain a first character string;
converting the first character string into plural first binary digits, storing the plural first binary digits;
decrypting the stored plural first binary digits using a pre-defined decryption algorithm to generate plural second binary digits; and
converting the plural second binary digits into a second character string;
wherein the converting the first character string into the plural first binary digits and storing the plural first binary digits comprise:
converting the to-be-decrypted first character string into a first character array, wherein an element in the first character array corresponds to a single-byte encoded value of a character in a third character string;
assigning elements in the first character array into plural array blocks according to a pre-defined value; wherein each array block includes elements whose number equals the pre-defined value; and
converting elements in each array block into 8-bit binary digits, and storing the 8-bit binary digits corresponding to each array block.

6. (canceled)

7. The method of claim 65, wherein when the pre-defined value is 4, the assigning single-byte encoded values corresponding to the elements in the first character array into the plural array blocks comprises:
assigning 4 successive elements into one array block in an order of the elements arranged in the first character array;
converting elements in each array block into 8-bit binary digits, and storing the 8-bit binary digits corresponding to each array block; and
converting each of the 4 elements in each array block into an 8-bit binary digit, and combining the 4 8-bit binary digits corresponding to each array block into a 32-bit binary digit; and
storing the 32-bit binary digit corresponding to each array block.

8. The method of claim 5, wherein the converting the plural second binary digits into the second character string comprises:
converting each 8 successive binary digits in the plural second binary digits into a single-byte encoded value to generate a second character array; and
converting the second character array into a second character string, wherein an element in the second character array corresponds to a single-byte encoded value of a character in the second character string.

9. An apparatus for communication encryption, comprising: a processor and a non-transitory memory, the memory comprising a set of computer-executable instructions causing the processor to carry out the steps of:
extracting a first character string that is to be encrypted from to-be-sent data;
converting the first character string into plural first binary digits and storing the plural first binary digits;
encrypting the stored plural first binary digits using a pre-defined encryption algorithm to generate plural second binary digits;
converting the plural second binary digits into a to-be-sent character string;
applying transmission encoding to the to-be-sent character string; and
sending a result of the encoding;
wherein the computer-executable instructions is further capable of causing the processor to carry out the steps of:
converting the to-be-encrypted first character string into a second character string; wherein each character in the second character string corresponds to one byte;
converting the second character string into a first character array, wherein an element in the first character array corresponds to a single-byte encoded value of a character in the second character string;
assigning elements in the character array obtained by the second conversion module into plural array blocks, wherein each array block includes a pre-defined number of elements;
converting elements in each array block into 8-bit binary digits; and
storing multiple 8-bit binary digits corresponding to each array block.

10. (canceled)

11. The apparatus of claim 9, wherein the computer-executable instructions is further capable of causing the processor to carry out the steps of:
assigning 4 successive elements into an array block in an order of elements arranged in the first character array when the pre-defined value is 4;
converting each of the 4 elements in each array block into an 8-bit binary digit, and combining the 4 8-bit binary digits corresponding to each array block into a 32-bit binary digit; and
storing the 32-bit binary digit corresponding to each array block.

12. The apparatus of claim 9, wherein the computer-executable instructions is further capable of causing the processor to carry out the steps of:
converting each 8 successive binary digits in the plural second binary digits into a single-byte encoded value to generate a second character array; and
converting the second character array into a to-be-sent character string; wherein an element in the second character array corresponds to a single-byte encoded value of a character in the to-be-sent character string.

13. An apparatus for communication decryption, comprising: a processor and a non-transitory memory, the memory comprising a set of computer-executable instructions causing the processor to carry out the steps of:
receiving to-be-processed data sent by a sending device;
applying transmission decoding to the to-be-processed data to obtain a first character string;
converting the first character string into plural first binary digits, and storing the plural first binary digits;
decrypting the stored plural first binary digits using a pre-defined decryption algorithm to generate plural second binary digits;
converting the plural second binary digits into a second character string; wherein the computer-executable instructions is further capable of causing the processor to carry out the steps of:
converting the to-be-decrypted first character string into a first character array; wherein an element in the first character array corresponds to a single-byte encoded value of a character in a third character string;
assigning elements in the character array into plural array blocks, wherein each array block includes a pre-defined number of elements;
converting elements in each array block into 8-bit binary digits; and
storing the 8-bit binary digits corresponding to each array block.

14. (canceled)

15. The apparatus of claim 13, wherein the, computer-executable instructions is further capable of causing the processor to carry out the steps of:
assigning 4 successive elements into an array block in an order of elements arranged in the first character array when the pre-defined value is 4;
converting each of the 4 elements in each array block into an 8-bit binary digit, and combining the 4 8-bit binary digits corresponding to each array block into a 32-bit binary digit; and
storing the 32-bit binary digit corresponding to each array block.

16. The apparatus of claim 13, wherein the computer-executable instructions is further capable of causing the processor to carry out the steps of:
converting each 8 successive binary digits in the plural second binary digits into a single-byte encoded value to generate a second character array; and
converting the second character array into a second character string; wherein an element in the second character array corresponds to a single-byte encoded value of a character in the second character string.

17. (canceled)
